(19) United States
(12) Patent Application Publication
(10) Pub. No.: US 2024/0168874 A1
(43) Pub. Date: May 23, 2024

(54) OPTIMIZING MEMORY CONFIGURATION IN MAINFRAME COMPUTERS

(71) Applicant: International Business Machines Corporation, Armonk, NY (US)

(72) Inventors: Erik Rueger, Ockenheim (DE); Ravinder Akula, Bangalore (IN); Jeevabharathy Murugesan, Bangalore (IN); Grzegorz Piotr Szczepanik, Kraków (PL)

(21) Appl. No.: 18/056,770

(22) Filed: Nov. 18, 2022

(51) Int. Cl. G06F 12/02

(52) U.S. Cl. CPC G06F 12/023

(57) ABSTRACT

A computer-implemented method for optimize memory configuration of a computer system. The computer-implemented method includes determining available online real storage assigned to the computer system. The method further includes computing, using a machine learning model, a Large Frame Area (LFAREA) value to support large pages used by one or more applications executing on the computer system, wherein the large pages are memory pages larger than a predetermined value. The method further includes dynamically updating the LFAREA value of the computer system to the determined LFAREA value to support the large pages of the computer system.

### BACKGROUND

The present invention relates to computing technology, and particularly to optimizing memory configuration(s) in a mainframe computer.

Many computer systems utilize a large frame area (LFAREA) to support the storage of large pages, such as pages equal to or larger than 1 megabyte (MB). The LFAREA includes one or more online real storage address increments. The real storage increments range from 64 MB to 2 gigabytes (GB) depending on the processor machine model. The number of pages to be reserved is requested via an LFAREA system parameter (e.g., LFAREA=24M is a request to reserve 24 1 MB pages in the LFAREA). Reserving a desired number of pages can be accomplished by scanning the real storage increments and selecting the real storage increments that are online and available until the requested amount is achieved. In many current systems the amount of storage that can be reserved in the LFAREA is limited to 80 percent of the online storage minus 2 GB.

As the page size of large pages used by computer systems increases, the page size may become larger than the real storage increments used by the computer system. As a result, the selection process becomes more complex because enough contiguous online and available real storage increments for each page area that is to be reserved has/have to be found. In addition, the selection process can be further complicated by gaps in storage increments caused by offline storage increments.

### SUMMARY

According to one or more embodiments of the present invention, a computer-implemented method for optimize memory configuration of a computer system. The computer-implemented method includes determining available online real storage assigned to the computer system. The method further includes computing, using a machine learning model, a Large Frame Area (LFAREA) value to support large pages used by one or more applications executing on the computer system, wherein the large pages are memory pages larger than a predetermined value. The method further includes dynamically updating the LFAREA value of the computer system to the determined LFAREA value to support the large pages of the computer system.

In one or more embodiments of the present invention, the computer system is a logical partition (LPAR) of a mainframe system.

In one or more embodiments of the present invention, the computer system is monitored continuously to compare one or more parameters associated with the LFAREA value with a knowledge base.

In one or more embodiments of the present invention, the LFAREA value is computed in response to the available online real storage being greater than a predetermined threshold.

In one or more embodiments of the present invention, the LFAREA value is determined by subtracting the predetermined threshold from a predetermined portion of the available online real storage at initial program load (IPL) of the computer system.

In one or more embodiments of the present invention, the predetermined portion of the available online real storage is computed by the machine learning model.

In one or more embodiments of the present invention, the computer system comprises a plurality of computer systems, and a respective LFAREA value is computed for each computer system.

According to one or more embodiments of the present invention, a system includes a memory device, and one or more processing units coupled with the memory device, the one or more processing units configured to optimize memory configuration of a logical partition (LPAR) of a mainframe system. Optimizing the memory configuration includes determining available online real storage assigned to the computer system. The method further includes computing, using a machine learning model, a Large Frame Area (LFAREA) value to support large pages used by one or more applications executing on the computer system, wherein the large pages are memory pages larger than a predetermined value. The method further includes dynamically updating the LFAREA value of the computer system to the determined LFAREA value to support the large pages of the computer system.

According to one or more embodiments of the present invention, a computer program product comprising a memory device with computer-executable instructions therein, the computer-executable instructions when executed by a processing unit perform a method to optimize memory configuration of a computer system. The method includes determining available online real storage assigned to the computer system. The method further includes computing, using a machine learning model, a Large Frame Area (LFAREA) value to support large pages used by one or more applications executing on the computer system, wherein the large pages are memory pages larger than a predetermined value. The method further includes dynamically updating the LFAREA value of the computer system to the determined LFAREA value to support the large pages of the computer system.

Embodiments of the invention described herein address technical challenges in vehicle operation, particularly in fields of remote operation of vehicles.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings.

FIG. 1 depicts an embodiment of a computing environment to incorporate and/or use one or more embodiments of the present invention;

FIG. 2A illustrates a storage map having thirty-one storage increments with each increment sized at 512 MB;

FIG. 2B illustrates a storage map having eight storage increments with each increment having a size of 2 GB;

FIG. 2C illustrates a storage map having four storage increments with each increment sized at 4 GB;

FIG. 3 depicts an example block diagram of an large frame area (LFAREA) computing module according to one or more embodiments of the present invention;

FIG. 4 depicts a flowchart of a method to dynamically compute LFAREA value of a computer system according to one or more embodiments of the present invention;

FIG. 5 depicts a computing environment in accordance with one or more embodiments of the present invention.

The diagrams depicted herein are illustrative. There can be many variations to the diagrams, or the operations described therein without departing from the spirit of the invention. For instance, the actions can be performed in a differing order, or actions can be added, deleted, or modified. Also, the term “coupled,” and variations thereof describe having a communications path between two elements and do not imply a direct connection between the elements with no intervening elements/connections between them. All of these variations are considered a part of the specification.

In the accompanying figures and following detailed description of the disclosed embodiments, the various elements illustrated in the figures are provided with two or three-digit reference numbers. With minor exceptions, the leftmost digit(s) of each reference number corresponds to the figure in which its element is first illustrated.

### DETAILED DESCRIPTION

Embodiments of the present invention facilitate management of real storage, and more specifically, to reserving fixed page areas in real storage increments using target request amounts. In a mainframe system (or mainframe computer), typical page sizes supported include 4 kilobyte (KB), 1 megabyte (MB) and 2 gigabyte (GB) in size. A mainframe system utilizes a Large Frame Area (LFAREA) to support the storage of large pages, such as pages equal to or larger than 1 MB or 2 GB. It is understood that the page sizes listed above are exemplary, and that different sizes can be used in one or more embodiments of the present invention.

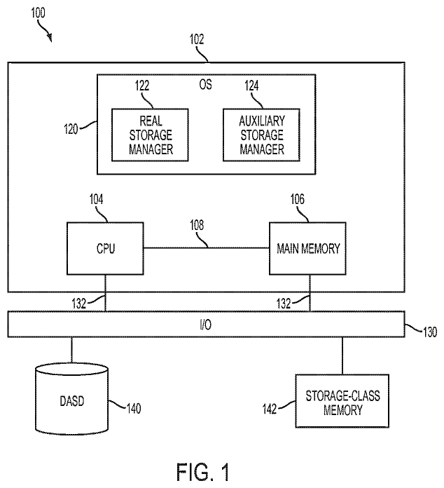

Referring now to FIG. 1, an embodiment of a computing environment to incorporate and/or use one or more embodiments of the present invention is shown. In exemplary embodiments, computing environment 100 includes a system 102, such as one or more servers, a central processing complex, etc., that includes, for instance, one or more central processing units (CPUs) 104 coupled to main memory 106, also referred to as real storage, via one or more buses 108. One of the central processing units 104 may execute an operating system 120, such as the z/OS® operating system offered by International Business Machines Corporation. In other examples, one or more of the central processing units may execute other operating systems or no operating system. z/OS® is a registered trademark of International Business Machines Corporation, Armonk, N.Y., USA.

Central processing unit(s) 104 and main memory 106 are further coupled to an I/O subsystem 130 via one or more connections 132 (e.g., buses or other connections). The I/O subsystem 130 provides connectivity to one or more auxiliary storage media, including, for instance, one or more direct access storage devices (DASD) 140 and storage class memory 142 (e.g., flash memory). In one particular example of the z/Architecture®, the I/O subsystem 130 is a channel subsystem. However, the I/O subsystem 130 may be a subsystem other than a channel subsystem, and the auxiliary storage media may be media other than or in addition to DASD 140 and storage class memory 142.

Main memory 106 and auxiliary storage are managed, in one example, by managers of operating system 120, including, for instance, a real storage manager 122 and an auxiliary storage manager 124. Real storage manager 122 is responsible for tracking the contents of main memory 106 and managing the paging activities of main memory. Auxiliary storage manager 124 is responsible for tracking auxiliary storage, including DASD 140 and storage class memory 142, and for working with the real storage manager 122 to find locations to store pages that are being evicted from main memory 106.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

The auxiliary storage manager 124 manages various types of auxiliary storage, including storage class memory 142, such as flash memory. In one embodiment, storage class memory 142 is read or written in varying storage block sizes, including 4K and 1 MB storage blocks, as examples. The operating system (e.g., auxiliary storage manager 124) keeps track of the blocks currently being used and by which system component. In exemplary embodiments, large pages (e.g., 1 MB or larger) include a plurality of contiguous pages (e.g. 256 for a 1 MB page) 4K pages, and each 4K page has associated therewith a page frame table entry (PFTE). Within each PFTE is an identifier that specifies the type of page, e.g., a 4 K page, a 1 MB page or a 2 GB page.

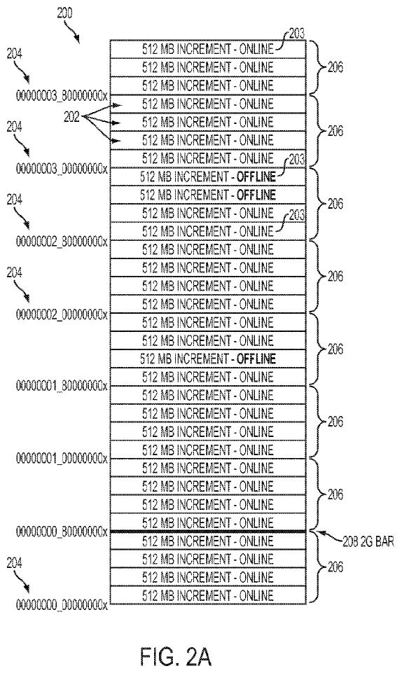

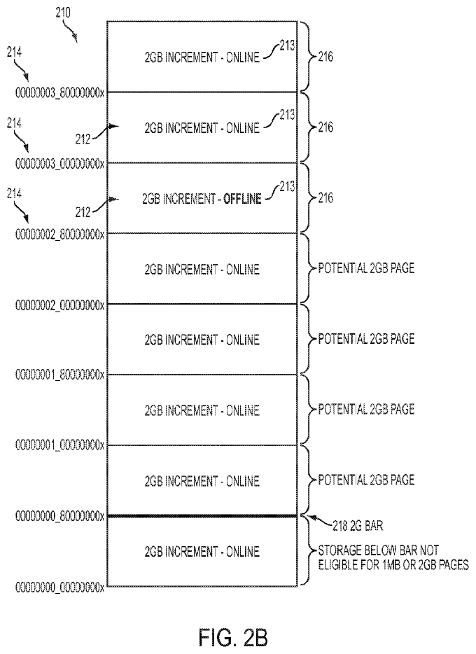

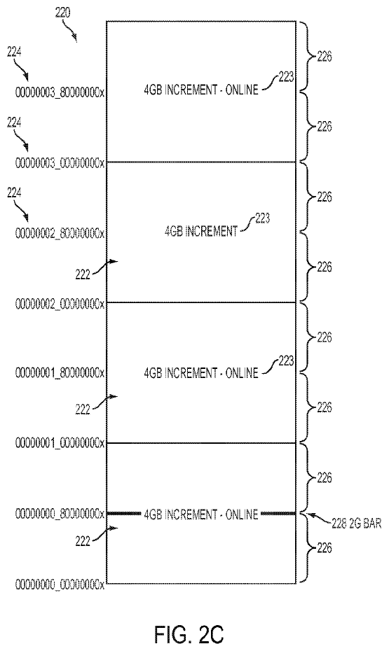

Referring now to FIGS. 2A-2C, block diagrams of real storage maps are shown. It will be appreciated by those of ordinary skill in the art that these storage maps are only for illustrative purposes as real systems will have more storage with the increment sizes shown.

FIG. 2A illustrates a storage map 200 having thirty-one storage increments 202 with each increment sized at 512 MB. Each of the storage increments 202 includes a status 203, which indicates if the storage increment 202 is online or offline. As illustrated, all but three of the storage increments 202 are online. The storage map includes seven sections 206 that start and end on a 2 GB boundary, with each section 206 including four storage increments 202. Each of the sections 206 includes an address 204, which indicates the starting address of the section 206. In exemplary embodiments, the first 2 GB section 206, which is the section 206 with the lowest address 204, cannot be reserved for a 2 GB page or for 1 MB pages because no real storage below bar 208 is available to be used for 1 MB or 2 GB pages. Sections 206 above the bar 208 that include four online increments 202 can potentially be used for 2 GB pages. However, storage sections 206 above the bar 208 that include one or more offline increments 202 or less than four online increments 202 can not be used as a 2 GB page. However, the online increments 202 of sections 206 that can not be used for 2 GB pages may be used for 1 MB pages. In addition, any of the sections 206 that can be used as 2 GB pages may also be used instead as 2048 1 MB pages.

FIG. 2B illustrates a storage map 210 having eight storage increments 212 with each increment having a size of 2 GB. Each of the storage increments 212 includes a status 213, which indicates if the storage increment 212 is online or offline. As illustrated, all but one of the storage increments 212 are online. As illustrated, the storage map includes eight sections 216 that start and end on a 2 GB boundary, with each section 216 including one storage increment 212. Each of the sections 216 includes an address 214, which indicates the starting address of the section 216. In exemplary embodiments, the first 2 GB section 216, which is the section 216 with the lowest address 214, can not be used as a 2 GB page or as 1 MB pages because no real storage below the bar 218 is available to be used for 1 MB or 2 GB pages. Each of the remaining online increments 212 are eligible to use as 2 GB pages, or as 2048 1 MB pages.

FIG. 2C illustrates a storage map 220 having four storage increments 222 with each increment sized at 4 GB. Each of the storage increments 222 includes a status 223, which indicates if the storage increment 222 is online or offline. As illustrated, all of the storage increments 222 are online. As illustrated, the storage map includes eight sections 226 that start and end on a 2 GB boundary. Each of the sections 226 includes an address 224, which indicates the starting address of the section 226. In exemplary embodiments, the first 2 GB section 226, which is the section 226 with the lowest address 224, can not be used as a 2 GB page or as 1 MB pages because no real storage below the bar 228 is available to be used for 1 MB or 2 GB pages. The remaining section 226 of the first increment 222 can be used as a 2 GB page (or as 2048 1 MB pages). In addition, each of the remaining increments 222 can be used as two 2 GB pages, one 2 GB page and 2048 1 MB pages, or 4096 1 MB pages.

The LFAREA includes one or more online real storage address increments. Reserving a desired number of pages can be accomplished by scanning the real storage increments and selecting the real storage increments that are online and available until the requested amount is achieved. In many current state-of-the-art systems the amount of storage that can be reserved in the LFAREA is limited to 80 percent of the online storage minus 2 GB.

As the page size of large pages used by the computer system 100 increases, the page size may become larger than the real storage increments used by the computer system 100. As a result, the selection process becomes more complex because it must find enough contiguous online and available real storage increments for each page area that is to be reserved. In addition, the selection process can be further complicated by gaps in storage increments caused by offline storage increments. These conditions pose a technical challenge to computer systems, such as mainframes, computer servers, or any other computing system that can be represented by the computer system 100.

Embodiments of the present invention address such technical challenges. Embodiments of the present invention facilitate improved system performance and reduce the overhead of dynamic address translation by accurately calculating the LFAREA value. Large pages provide performance value to a select set of applications that can generally be characterized as memory intensive and long running. These applications generally refer large ranges of memory and they exhaust the private storage above and below the 2 GB limit.

Presently, large pages of 1 MB or 2 GB in size are fixed in the central storage by specifying LFAREA value in system parameters member during initialization of the system 100. If the value specified is too small, creation of large pages is not possible thereby degrading the performance of applications which depend on the large pages. If the value specified is too large, 1 MB pages could be used as 4 KB frames, thereby causing overhead to the CPU 104 due to the conversion. Accordingly, specifying a suitable value of the LFAREA parameter is critical for optimal use. Current state-of-the-art method of calculating the LFAREA value includes determining the number of 1 MB and 2 GB pages required for the applications by estimating such numbers based on a command for displaying virtual storage information, for example, the output of D VIRTSTOR, LFAREA system command in z/OS®.

Alternatively, or in addition, in some existing methods, system manuals are used to refer to formulas for human-based calculation, which are difficult for system programmers to understand and calculate the suitable values. That difficulty is accentuated due to separate and distinct syntax methods and percentage calculation formulas in some cases. Accordingly, in mainframe computing, the method to determine an LFAREA value to be used varies and is not a standard process. Determining the LFAREA involves manual calculation, which may result in errors based on estimates.

If the value is improperly calculated, a system wide outage is required to fall back to the previous value, which is not only undesirable, but also very cost and resource intensive. Embodiments of the present invention address such technical challenges, and provide a fully automatic solution. Beyond just automation, embodiments of the present invention facilitate building a scalable system that determines a formula specific to the computer system 100, where the formula for the (specific) computer system 100 uses parameters that are specific to that computer system 100. The developed formula tunes the system parameters and adapts to future needs of and changes to the system 100.

In turn, using the developed formula, embodiments of the present invention provide a consolidated way to calculate the optimal LFAREA value (replacing multiple complex formulae used in the state-of-the-art). Further, embodiments of the present invention facilitate dynamically updating system configuration with the optimal LFAREA value based on system and application runtime behavior/performance. The LFAREA value determination can be part of the computer system 100 itself, or a separate end-to-end platform, which can be deployed as a standalone solution. The LFAREA value determination system extracts actionable insights from the computer system 100 that is to be optimized, and determines the LFAREA value with which the computer system 100 is to be updated. In some embodiments of the present invention, the LFAREA value determination can further include a scalable infrastructure for building enterprise-level artificial intelligence (AI) capability with inbuilt knowledgebase which leverages machine learning and/or AI capabilities, including data analytics, which serves as the data processing cluster and delivers advanced data analytics for large page data processing, model training and extracts data from exploiters such as Java Virtual Machine (JVM), DB2®, z/OS® Container Extensions (ZCX), etc.

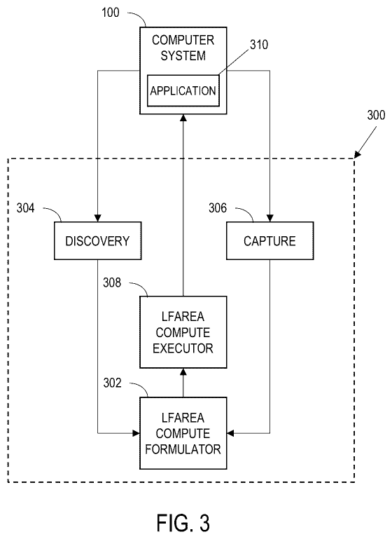

FIG. 3 depicts an example block diagram of an LFAREA computing module 300 according to one or more embodiments of the present invention. The LFAREA computing module 300 includes, among other components, an LFAREA formulator 302, a discovery module 304, a capture module 306, and a LFAREA compute executor 308. The components can each include hardware and/or software. In some embodiments of the present invention, the LFAREA computing module 300 is a computing system, device, or apparatus that is in communication with the computer system 100, e.g., mainframe system. Alternatively, the LFAREA computing module 300 includes one or more computer-executable instructions that can be executed using one or more processing units, for example, those from the computer system 100. It should be noted that the depicted components are exemplary, and that in other embodiments of the present invention, the LFAREA computing module 300 can include different, additional, and/or fewer components. For example, the depicted components can be combined and or split into additional or different sub-components in some embodiments of the present invention.

The discovery module 304 identifies the application 310 executing on the computer system 100 that needs tuning (memory intensive and long running). The discovery module 304 identifies the application 310 by monitoring the usage of one or more computing resources and/or time of execution of the application 310 and comparing the monitored values with corresponding predetermined thresholds. Alternatively, or in addition, an operator may provide an identification of the application 310. Other known or future developed techniques can be used for discovering the application 310 that has to be optimized in other embodiments of the present invention. The application 310 can be any computer program that is being executed on the computer system 100. The identification of the application 310 can be noted as a unique identifier associated with an execution instance (e.g., computer process) of the application 310.

The capture module 306 facilitates gathering and collecting system relevant parameters for calculating the LFAREA value for the computer system 100. The capture module 306 may be instructed to capture particular system parameters dynamically (during runtime) based on the specific parameters used for calculating the LFAREA value for the computer system 100.

The LFAREA formulator 302 determines a formula to be used for computing the LFAREA value for the computer system 100. The LFAREA formulator 302 uses machine learning (ML) in one or more embodiments of the present invention. The LFAREA formulator 302 uses values of the one or more system parameters that are monitored by the capture module 306 to output a formula that is to be used for determining the LFAREA value specific to the computer system 100. The formula that is output can be a mathematical equation that uses one or more system parameters of the computer system 100. Alternatively, or in addition, the formula that is output includes a set of rules that use the system parameters of the computer system 100 to determine the LFAREA value. In one or more embodiments of the present invention, the LFAREA formulator 302 updates the formula continuously at a predetermined frequency, for example, every hour, every day, etc. The frequency of updating the formula can be configured. In one or more embodiments of the present invention, the formula can be updated in real time, while the computer system 100 is in operation (i.e., running).

The LFAREA formula executor 308 executes the latest formula that is output by the LFAREA formulator 302 and computes the LFAREA value for the computer system 100. The LFAREA formula executor 308 uses the formula and one or more system parameter values as monitored by the capture module 306. In one or more embodiments of the present invention, the LFAREA compute executor 308 forwards the computed LFAREA value to the computer system 100. The computer system 100 may be reconfigured to use the computed LFAREA value.

In one or more embodiments of the present invention, the LFAREA formula executor 308 operates at a predetermined frequency to update the LFAREA value. In some embodiments of the present invention, the LFAREA formula executor 308 operates at the same frequency at which the LFAREA formulator 302 operates. In other embodiments of the present invention, the two modules operate at distinct frequencies.

Accordingly, the LFAREA computing module 300 is continuously updated using the system parameters of the computer system 100, wherein the updating of the LFAREA computing module 300 includes updating the formula. The formula is particular to the computer system 100. Further, the LFAREA computing module 300 continuously computes an updated LFAREA value for the computer system 100 based on the system parameters specifically of the computer system. The LFAREA value is further used to update/reconfigure the computer system 100. The update can include executing a command to update the LFAREA value.

Further, while FIG. 3 depicts the LFAREA computing module 300 coupled with a single computer system 100, in some embodiments of the present invention, the LFAREA computing module 300 can be coupled with multiple computer systems 100. The LFAREA computing module 300 can communicate with the one or more computer systems 100 in a wireless or wired manner. The LFAREA computing module 300 determines a formula for each respective computer system 100. Further, the LFAREA computing module 300 updates each of the computer systems 100 based on the respective formula and corresponding resulting LFAREA values.

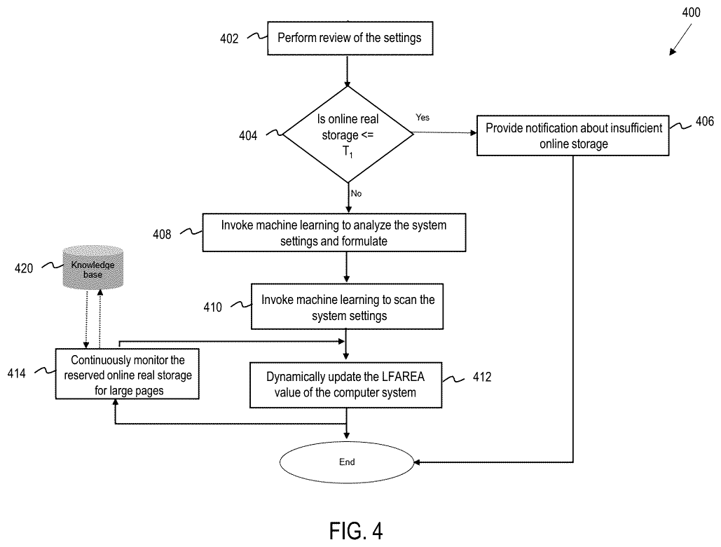

FIG. 4 depicts a flowchart of a method 400 to dynamically compute LFAREA value of a computer system according to one or more embodiments of the present invention. The method 400 includes, at block 402, performing a review of the computer system 100 to gain actionable insights based on the existing settings of the computer system 100. The actionable insights can include one or more system parameter values of the computer system 100. In one or more embodiments of the present invention, the computer system 100 is a logical partition (LPAR) of a mainframe system.

For example, the system parameter values include available online real storage in the computer system 100. Further, the system parameter values can include identification of an operating system, processor specifications, network specifications, number of installed applications, number of applications being executed at present, list of the applications being executed, storage map, etc.

At block 404, the system parameters are checked with predetermined values. For example, it is checked, if the real storage assigned to the computer system 100 is less than or equal to a predetermined amount (e.g., 4 GB). At block 406, if the predetermined amount of real storage is not assigned to the computer system, a notification provided. The notification can be a message that is displayed. The message can specify that the assigned amount of storage (e.g., 4 GB) is not enough online real storage to support fixed large pages (e.g., 1 MB or 2 GB). Further, at block 406, the LFAREA value computation terminates.

At block 408, if the real storage assigned to the computer system 100 is more than the predetermined amount then the LFAREA computing module 300 invokes ML and/or data analytic model to update the recommended value of LFAREA to support large pages.

The ML model can use application programming interfaces (APIs), e.g., Watson Machine Learning on z/OS®, which provide ML and data analytics capabilities. Alternatively, or in addition, the ML model can be pre-built that facilitates analyzing the system parameters and settings of the computer system 100 to determine a formula for the LFAREA value for the computer system based on the analysis. For example, the ML model is programmed to ingest system log records (e.g., captured by System Management Facilities (SMF)) for model training and scoring. Based on the system log records that include the system settings, the ML model analyzes consumption of large frames by the one or more applications executing on the computer system 100 at the time of those records. In some embodiments, the calculations performed and the resulting LFAREA values used at the time of those records are also input to the ML model. Using the historical data of calculations, system parameters, and related performance, the ML model is trained to influence future calculations and decisions of LFAREA value of the computer system 100. In some embodiments of the present invention, the ML model generates and outputs a report showing the consumption of large frames. The report can highlight peak values to assist in root cause diagnosis of the resulting LFAREA values historically used in some embodiments of the present invention. In some embodiments of the present invention, the ML model training can be optimized by leveraging DB2 AI for z/OS®. Such technology allows for rapid model learning specific to the data and configuration per computer system 100 (e.g., per LPAR of a mainframe system).

The ML model can output a formula to compute an optimal LFAREA value for the computer system 100 given the present system settings and parameters captured. For example, the formula can be a percentage (x %) of the online real storage of the computer system to be used as the LFAREA value. For example, the ML model suggests calculating the requested number of 1 MB pages to reserve using the following formula:

Number of 1 MB pages to reserve=(x %*online real storage at initial program load (IPL), in MB)−y MB.

Here, x and y are determined by the ML model, and can have values such as x %=80%, 75%, 60%, etc.; and y=2048 MB, 1024 MB, 512 MB, etc.

Alternatively, the formula can be expressed as:

Number of 1 MB pages to reserve=[(x %*online real storage in GB)−y GB]*1024.

In some embodiments of the present invention, the formula provides percentages specifying a target and a minimum LFAREA value. The requested target and minimum number of 1 MB pages to reserve are calculated using the formula:

Number of 1 MB pages to reserve=(target % or minimum %)*(online real storage at IPL in MB−y MB).

Here, target, minimum, and y are values output by the ML model. The formula can also be expressed as:

Number of 1 MB pages to reserve=(target % or minimum %*(online real storage at IPL in GB−y GB))*1024

In some embodiments of the present invention, if percentages (target % and minimum %) are specified, the requested target or minimum number of 2 GB pages to reserve is calculated using the formula:

Number of 2 GB pages to reserve=target % or minimum %*(online real storage at IPL in GB−y GB)

Some of the applications that are executing on the computer system 100 may be processing amounts of data more than a predetermined threshold. For such amounts of data, a combination of 1 MB and 2 GB large pages are required for optimal performance. Hence, the LFAREA computing module 300 determines the maximum amount of online real storage that can be reserved for the computer system and the number of 1 MB and 2 GB pages to allocate, at block 410. The computation can be based on the formula (such as those above) output by the ML model.

At block 412, the LFAREA computing module 300 updates the LFAREA value of the computer system 100 (e.g., LPAR) using the computed LFAREA value based on the ML model. Accordingly, the computer system 100 is optimized.

Further, at block 414, the LFAREA computing module 300 continuously monitors the computer system 100 for reserved online real storage for large pages. In some embodiments of the present invention, the number of large pages is compared with predetermined values from a knowledge base (420). If the number of large pages is does not match (fewer, greater) with the values from the knowledge base 420, LFAREA value may be updated based on the available online real storage value at present (block 412). The formula that was most recently generated by the ML model is used again, with the updated system setting values to compute a new LFAREA value.

In some embodiments of the present invention, the ML model may be invoked again to update the formula for the LFAREA value, and subsequently a new LFAREA value is computed (410, 412). In yet other embodiments of the present invention, the ML model is invoked at a predetermined frequency to ensure that the formula for the LFAREA value for the computer system 100 is always up to date.

Embodiments of the present invention facilitate dynamically computing and updating LFAREA value of a computer system, e.g., mainframe system. Accordingly, embodiments of the present invention address one or more technical challenges rooted in computing technology, particularly memory organization of computer systems. Hence, embodiments of the present invention are rooted in computing technology and provide an improvement to computing technology, particularly operation of computer system by a optimizing memory organization. Alternatively, or in addition, embodiments of the present invention provide practical applications in the field of computing technology, particularly memory organization of computer systems, e.g., mainframe systems, by dynamically computing and adjusting LFAREA value.

Further, one or more embodiments of the present invention facilitate reducing critical resource shortage issues, and thereby preventing system outages because of automated, accurate, and specific calculation of LFAREA value. Further, embodiments of the present invention facilitate standardized, yet custom way to calculate the LFAREA value based on central storage to support large pages, which generates a recommended LFAREA value at system speed during runtime. Embodiments of the present invention further facilitates reserving online real storage to meet large page requirements of the particular computer system. Embodiments of the present invention, in turn, facilitate uses of the computer system, e.g., mainframe, to migrate to large(r) applications involving big data without impacting the system performance as the memory organization is dynamically and accurately calculated by updating the LFAREA value.

A computer program product embodiment (“CPP embodiment” or “CPP”) is a term used in the present disclosure to describe any set of one or more storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

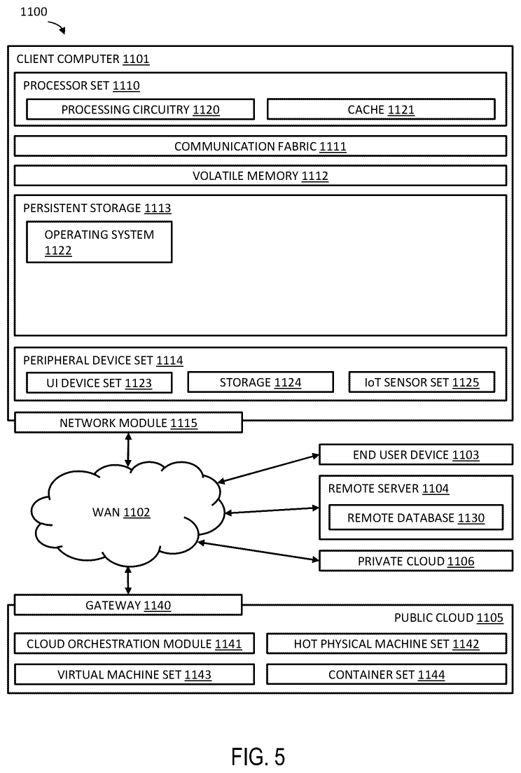

FIG. 5 depicts a computing environment in accordance with one or more embodiments of the present invention. Computing environment 1100 contains an example of an environment for the execution of at least some of the computer code involved in performing the inventive methods, such as determining the formula for the LFAREA value, computing the LFAREA value, etc. Computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smartwatch or other wearable computer, mainframe computer, quantum computer or any other form of computer or mobile device now known or to be developed in the future that is capable of running a program, accessing a network, or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The present invention can be a system, a method, and/or a computer program product at any possible technical detail level of integration. The computer program product can include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for optimize memory configuration of a computer system, the computer-implemented method comprising:
determining available online real storage assigned to the computer system;
computing, using a machine learning model, a Large Frame Area (LFAREA) value to support large pages used by one or more applications executing on the computer system, wherein the large pages are memory pages larger than a predetermined value; and
dynamically updating the LFAREA value of the computer system to the determined LFAREA value to support the large pages of the computer system.

2. The computer-implemented method of claim 1, wherein the computer system is a logical partition (LPAR) of a mainframe system.

3. The computer-implemented method of claim 1, wherein the computer system is monitored continuously to compare one or more parameters associated with the LFAREA value with a knowledge base.

4. The computer-implemented method of claim 1, wherein the LFAREA value is computed in response to the available online real storage being greater than a predetermined threshold.

5. The computer-implemented method of claim 4, wherein the LFAREA value is determined by subtracting the predetermined threshold from a predetermined portion of the available online real storage at initial program load (IPL) of the computer system.

6. The computer-implemented method of claim 5, wherein the predetermined portion of the available online real storage is computed by the machine learning model.

7. The computer-implemented method of claim 1, wherein the computer system comprises a plurality of computer systems, and a respective LFAREA value is computed for each computer system.

8. A system comprising:
a memory device; and
one or more processing units coupled with the memory device, the one or more processing units configured to optimize memory configuration of a logical partition (LPAR) of a mainframe system, wherein optimizing the memory configuration comprises:
determining available online real storage assigned to the LPAR;
computing, using a machine learning model, a Large Frame Area (LFAREA) value to support large pages used by one or more applications executing on the LPAR, wherein the large pages are memory pages larger than a predetermined value; and
dynamically updating the LFAREA value of the LPAR to the determined LFAREA value to support the large pages of the LPAR.

9. The system of claim 8, wherein the LPAR is monitored continuously to compare one or more parameters associated with the LFAREA value with a knowledge base.

10. The system of claim 8, wherein the LFAREA value is computed in response to the available online real storage being greater than a predetermined threshold.

11. The system of claim 10, wherein the LFAREA value is determined by subtracting the predetermined threshold from a predetermined portion of the available online real storage at initial program load (IPL) of the LPAR.

12. The system of claim 11, wherein the predetermined portion of the available online real storage is computed by the machine learning model.

13. The system of claim 8, wherein the LPAR is a plurality of LPARs, and a respective LFAREA value is computed for each LPAR.

14. A computer program product comprising a memory device with computer-executable instructions therein, the computer-executable instructions when executed by a processing unit perform a method to optimize memory configuration of a computer system, the method comprising:
determining available online real storage assigned to the computer system;
computing, using a machine learning model, a Large Frame Area (LFAREA) value to support large pages used by one or more applications executing on the computer system, wherein the large pages are memory pages larger than a predetermined value; and
dynamically updating the LFAREA value of the computer system to the determined LFAREA value to support the large pages of the computer system.

15. The computer program product of claim 14, wherein the computer system is a logical partition (LPAR) of a mainframe system.

16. The computer program product of claim 14, wherein the computer system is monitored continuously to compare one or more parameters associated with the LFAREA value with a knowledge base.

17. The computer program product of claim 14, wherein the LFAREA value is computed in response to the available online real storage being greater than a predetermined threshold.

18. The computer program product of claim 17, wherein the LFAREA value is determined by subtracting the predetermined threshold from a predetermined portion of the available online real storage at initial program load (IPL) of the computer system.

19. The computer program product of claim 18, wherein the predetermined portion of the available online real storage is computed by the machine learning model.

20. The computer program product of claim 14, wherein the computer system comprises a plurality of computer systems, and a respective LFAREA value is computed for each computer system.
